(19) United States
(12) Patent Application Publication
(10) Pub. No.: US 2007/0061159 A1
(43) Pub. Date: Mar. 15, 2007

(54) Method for determining sexual compatibility

(76) Inventor: Herb D. Vest, Dallas, TX (US)

Correspondence Address: CARSTENS & CAHOON, LLP, P O BOX 802334, DALLAS, TX, 75380, US

(21) Appl. No.: 11/223,597

(22) Filed: Sep. 9, 2005

(51) Int. Cl. G06Q 99/00

(52) U.S. Cl. 705/1

(57) ABSTRACT

A method is provided for selecting and matching persons based on their sexual personality types. The method includes a process for qualifying a user to participate in a testing process, administering a test to determine a person's preferences with respect to particular aspects of sexual behavior, and reporting the results to a user. A plurality of different factors is independently tested to assist in recognizing a person's sexual personality type. The user's responses to the test questions are statistically analyzed based on previously acquired population data to reach a conclusion with respect to a user. The results of the testing process are then provided to the user along with related information.

### BACKGROUND OF THE INVENTION

1. Technical Field

The present invention relates generally to automated online testing of individuals or users to determine their sexual preferences.

2. Description of Related Art

With the increasing role of computers and the Internet in daily life, more and more people are establishing and maintaining friendships and relationships through electronic means of communication and interaction. The Internet has allowed a multitude of companies to introduce services that cater to matching individuals. These services vary in sophistication from online classified advertisements to sophisticated operations that match individuals based on individual qualities and preferences.

The online dating services are extremely competitive. Success in the industry is measured by successful matching of individual persons. Each participant in the industry approaches the techniques to match individuals differently. For instance, some services match people based on compatible social behavior, religious beliefs, or personalities. The on-line matchmaking community has essentially ignored sexual behavior even though sexual behavior is such a critical component of many serious relationships. The need exists for a tool and method for matching people based on sexual personalities.

### SUMMARY OF THE INVENTION

On-line dating services are an increasingly popular tool for singles looking for both dates and mates. The service charges a monthly fee and in return presents a series of profiles to the user to review. If a profile seems appealing, then the user can contact that person to arrange a meeting. Unfortunately, the profile usually only provides a cursory summary of the person's background along with a photo. Choices are usually based on solely on looks. Sometimes these choices lead to meaningful relationships, but something is missing from the profiles, namely an honest assessment about the person's sexuality.

However, our sexuality is perhaps the single most important factor in finding someone compatible with whom to spend a weekend or a lifetime. Likewise, without first understanding the sexual “type” of those using the service, the online dating service will have a difficult time pairing persons successfully. Eight different sexual preference types have been identified: the Traditionalist, the Maverick, the Intellectual, the Fantasizer, the Contradictor, the Introvert, the Initiator, and the Subservient. The present invention is a system for classifying users within an online dating service into one of eight different sexual preference categories. Once a person understands his or her sexual preference type, it becomes easier for the person to be matched with others of compatible sexual preference types.

First, the user must log in to the system. This requires that he answer a series of basic questions about himself such as name, address and age. These questions are referred to in the present invention as “qualifying questions.” An unwillingness to answer these questions could result in the test not being administered to the user.

The testing process is broken into factors. For example, in the present invention, three factors are used in the testing process: “General Sexual Preferences,” “Self Behavior Preferences,” and “Partner Behavior Preferences.” The pool of questions for the testing process is divided such that three different “factor question groups.” For each factor, the user is asked three initial questions. After answering the three initial questions for a particular factor, a “score” is computed as well as a “confidence value.” The score provides a numerical representation of a particular user's expected beliefs with respect to a factor. The confidence value represents the statistical probability of the estimated score accurately representing the user.

If the confidence value is below a certain critical value, i.e. the estimated score is not likely to be accurate, the testing process for the particular factor continues. Each subsequent question is chosen based on computerized adaptive testing methods, or CAT methods. After each subsequent question, the score and confidence value are then recalculated. If the confidence value is still too low, the process repeats until either the confidence value exceeds a certain threshold, i.e. reasonable confidence that the estimated score accurately reflects the user, or the questions available are exhausted, in which case the current score is used, regardless of the confidence value.

The entire questioning process is repeated for each of the remaining factors, i.e. “self behavior preference” and “partner behavior preference.” For each of the remaining factors, three new initial questions are chosen from the particular factor question group and asked of the user. An estimated score and confidence value for the particular factor is computed and additional questions are asked until the questions are exhausted or the confidence value exceeds a certain threshold.

The score for each factor is characterized as either high, representing an adventurous attitude with respect to the factor, or low, representing a more conservative attitude toward the particular factor. With two different possibilities, high and low, for each factor, and three factors, there are eight different combinations representing the eight different sexual types mentioned earlier. For example, if a user is characterized as high on the general sexual preference, low on the self behavior preference, and high on the partner behavior preference, the user may be classified as a Subservient. These persons would be most compatible with an Initiator, then a Contradictor, then a Maverick and so on. This information makes matching people based on their sexual type much easier.

### BRIEF DESCRIPTION OF THE DRAWINGS

The novel features believed to be unique to the present invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems by means of which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts an illustration of the basic concept of the present invention.

FIG. 5 depicts a more detailed flow chart of an embodiment utilizing an adaptive testing process.

FIG. 6 depicts an example graph demonstrating the use of factor characterizations to determine a sexual personality type.

### DETAILED DESCRIPTION OF THE INVENTION

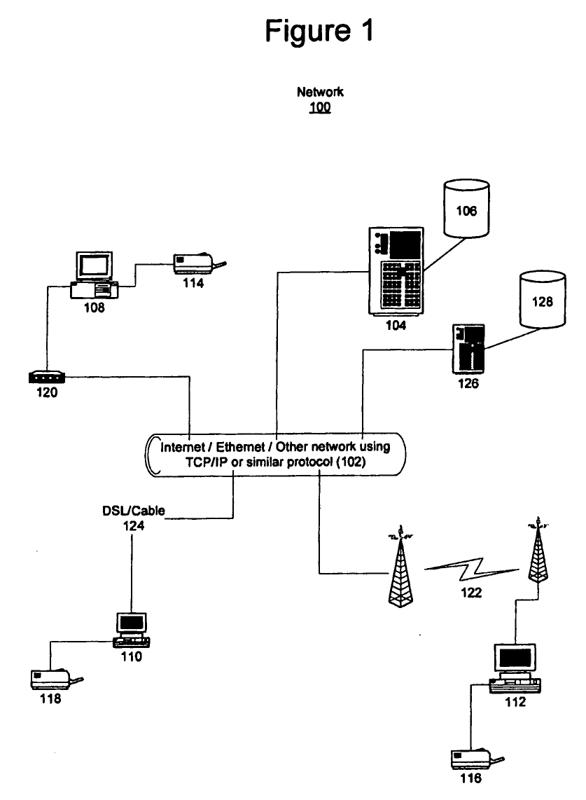

With reference now to the figures, FIG. 1 is a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Network data processing system 100 might also contain a supplementary server 126 and additional data storage 128.

Clients 108, 110, and 112 are clients to server 104. Network data processing system 100 includes printers 114, 116, and 118, and may also include additional servers, clients, and other devices not shown. The means by which clients 108-112 connect to the network 102 may include conventional telephone landline 120, broadband Digital Service Line (DSL) or cable 124, or wireless communication network 122.

In the depicted example, network data processing system 100 is the Internet with network 102 representing a worldwide collection of networks and gateways that use the TCP/IP suite or similar protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

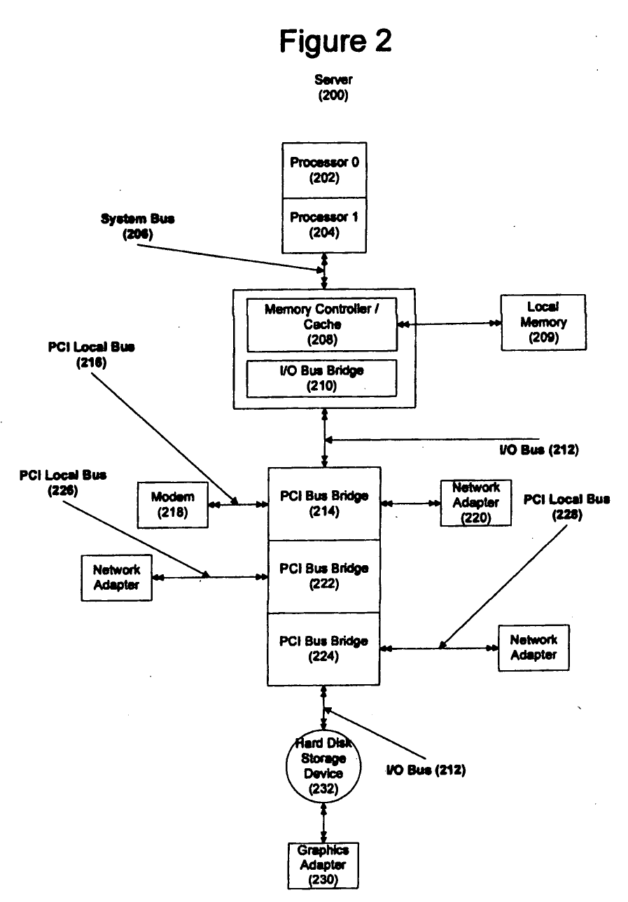

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communication links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pSeries system, a product of International Business Machines Corporation in Armonk, N.Y., running the Advanced Interactive Executive (AIX) or Linux operating systems.

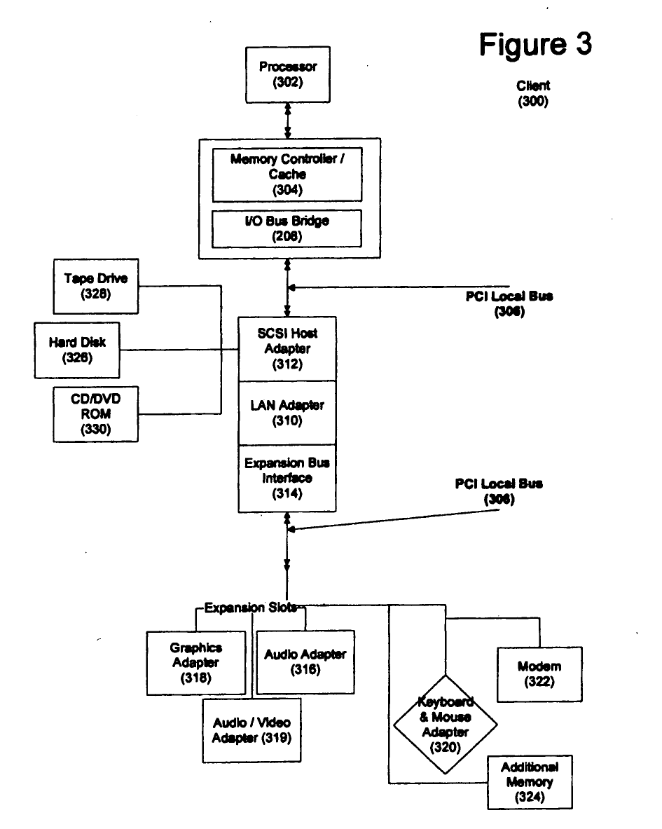

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD/DVD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and the above-described examples are not meant to imply architectural limitations. For example, data processing system 300 also may be a notebook computer or hand-held computer in addition to taking the form of a PDA. Data processing system 300 also may be a kiosk or a Web appliance.

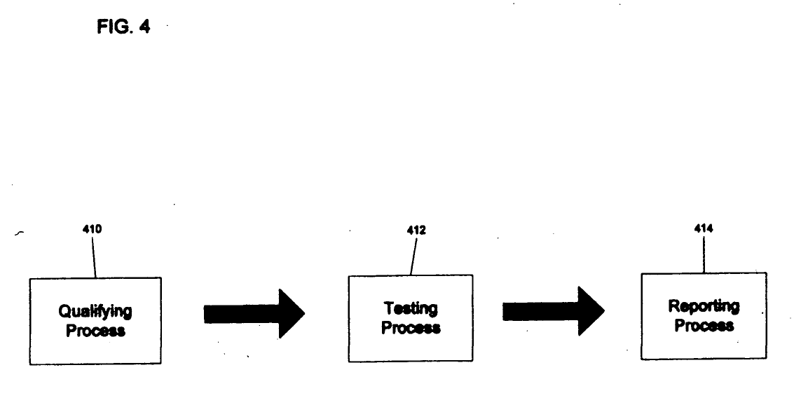

FIG. 4 illustrates a broad overview of the present invention. The three steps of the present invention are the qualifying process 410, the testing process 412, and the reporting process 414. The present invention is conducted by a testing server, of any suitable type described previously. The user is any person who wishes to determine their sexual personality type by participating in a test described in the present invention. The user may utilize any sort of client described previously to connect to the testing server.

The first process of the present invention, the qualifying process 410, involves acquiring one or more pieces of identifying information about the user. A nonexhaustive list of suitable pieces of identifying information includes: a first name, a last name, a computer handle, an address, a location, a nickname, a browser cookie, or any combination of the above pieces of information. The qualifying process 410 permits tracking of the user in the future. For instance, it may allow a user who has not finished the test to return to the test and complete the test at a later time. The qualifying process 410 also permits a user's sexual preference type and answers to be stored. The stored answers and sexual preference type can then be compared with other people at later date to match persons of compatible sexual personality types. Additionally, the information acquired in the qualifying process 410 may be used to determine appropriate questions for the testing process 412.

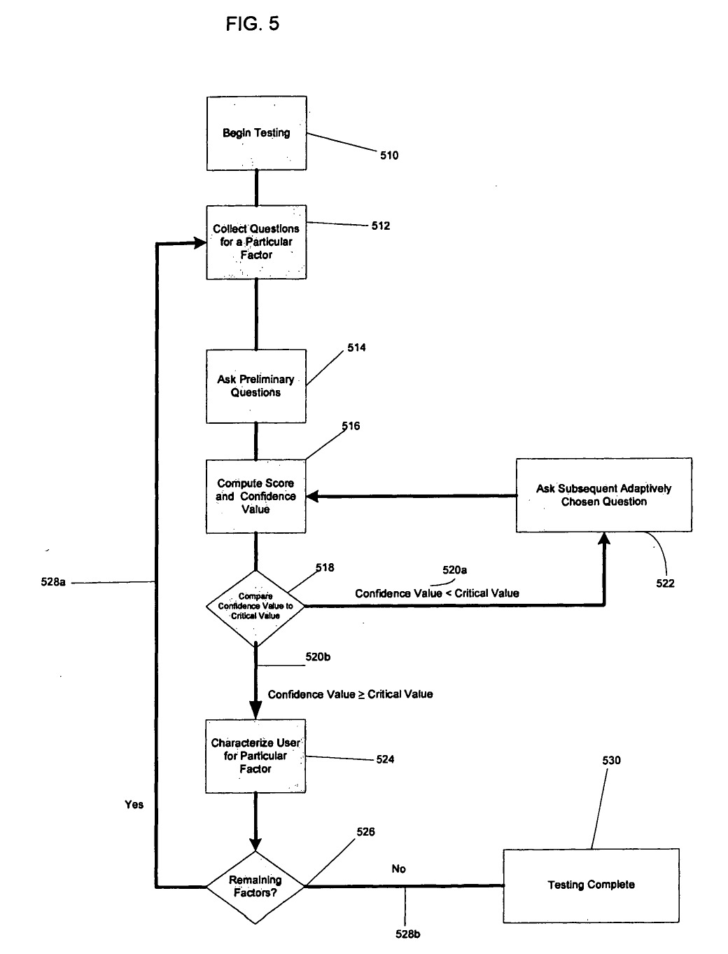

The second process in the present invention as illustrated in FIG. 4 is the testing process 412. The testing process 412 is an interactive procedure between the testing server and the user to determine the user's preferences with respect to certain factors. The testing process 412 is best explained by referencing FIG. 5.

FIG. 5 is a flow-chart representation of the testing process. The testing process begins after the user has completed the qualifying process. The first step in the testing process is to collect the questions for a particular factor (step 512). A large pool of questions is used in the testing process. For example, the pool of questions used for testing may contain a total of ninety different questions. Collecting the questions for the various factors requires the separation of the questions into n groups where n is the number of factors. For example, in one embodiment there are three factors “General Sexual Preference,” “Self Behavior Preference,” and “Partner Behavior Preference.” If the pool of questions for the testing process contains ninety questions, thirty questions may be specifically designed for use in determining “General Sexual Preference,” thirty may be specifically designed for use in determining “Self Behavior Preference,” and thirty may be specifically designed to assist in determining “Partner Behavior Preference.” If the first factor, “General Sexual Preference” is being determined, the thirty questions related to “General Sexual Preference” will be used to characterize the user with respect to that particular factor. The groups of questions are known as “factor question groups.”

After collecting the questions for a particular factor (step 512), the collected questions, or the factor question group, is used to determine the user position with respect to a particular factor through a series of questions. Using questions from the factor question group, one or more preliminary questions are asked of the user (step 514). In one embodiment, the testing server asks the user three preliminary questions for the first particular factor. Generally, the preliminary questions are identical for every user for each particular factor, but external considerations may be used in selecting preliminary questions, such as using identifying information obtained in the qualifying process, i.e. gender or age. After asking the preliminary questions, a user score and a confidence value is computed based on the user's particular responses (step 516). The confidence value as used herein is a generic reference to any value that represents the statistical accuracy of the user score. One example of a confidence values are z-scores, but any number of different statistical methods can be used to achieve the same result.

In one particular embodiment, a user score is calculated after the preliminary question and each subsequent question based on the responses of the user to the questions for a particular factor, known as the factor question group. Each answer choice for a particular question has a particular value associated with it used to compute a user score. As an example, the answer choices may be associated with a step value that is used to calculate the user score. Each value associated to a particular answer and a particular question is generally determined based on previously conducted clinical research. The user score itself is calculated using every question and answer provided by the user for a particular factor. For instance, if a user has answered five questions for the “general sexual preference” factor, the answer choices and associated value selected by the user for all five questions is used in computing the user score. The resulting user score numerically represents where the user is located with respect to a particular factor. The user score is indicative of the user's leaning for a particular factor. For example, the user score for the “general sexual preference factor” may range from −1.57, representing a more liberal, adventurous attitude toward sex, to 2.78, representing a more conservative attitude towards sex The user score represents the users predicted position with respect to a particular factor. The confidence value, however, is critical in determining the accuracy of the user score. For example, if the confidence value is low, for instance 10%, it is difficult to know if user score accurately represents the user. On the other hand, if the confidence value is calculated to be high, i.e. 95%, the estimated score is likely to represent the user's true belief more accurately. The confidence value is calculated using generally applicable statistical methods.

After calculating a user score and a confidence value for a particular factor (step 516), the computed confidence value is compared against a critical value. For example, the confidence value may be representative of a range from 0% to 100% and the critical value may be 90%. If the confidence value is less than 90%, the testing process continues by asking an additional questions from the particular factor question group. In this case, the testing process follows line 520a to ask a subsequent adaptively chosen question (step 522.) If the computed confidence value exceeds 90% or no questions remain in the factor question group, the testing process follows line 520b to characterize a user for a particular factor 524.

Addressing the first scenario, if additional questions remain and the confidence value does not exceed the critical value, the next step involves asking an adaptively chosen subsequent question (step 522). Adaptively chosen questions are questions that are calculated to best assist in determining an accurate estimated score, or a high confidence value. For example, if a user is tending to answer the questions with choices that are more adventurous leaning, the questions will tend to be slightly more adventurous in content. Thus, the response gives a better idea of whether the user truly leans a particular direction, This will translate into a higher confidence value, or more accurate score. After each adaptively chosen subsequent question, the score and confidence value are recalculated (step 516)

In the alternative, if the confidence value exceeds the critical value, or no additional questions remain in the factor question group, the testing process follows line 520b toward completion. Subsequently, the next step is to characterize the user for a particular factor (step 524). In the previously mentioned exemplar, the first factor was “General Sexual Preference.” The characterization is based on the most recently computed score. Generally, the characterization will be based on whether the computed score is higher than predetermined threshold (“High”) or below a certain predetermined threshold (“Low”). After completion of the testing process 530, the characterizations of the various factors will be used to report a sexual personality type to the user, as discussed later.

After characterizing a user for a particular factor (step 524), the next step depends on whether any factors remain untested (step 526). For example, in one embodiment, the “General Sexual Preference” factor is tested first and after completion and characterizing the user for this first particular factor, the “Self Behavior Preference” and “Partner Behavior Preference” factors remain. If a factor remains untested, the testing process follows line 528a back to the question collecting step (step 512) with the next factor question group collected. The testing procedure continues as described above with this next factor question group. If no factors remain untested, the testing process follows line 528b to completion 530.

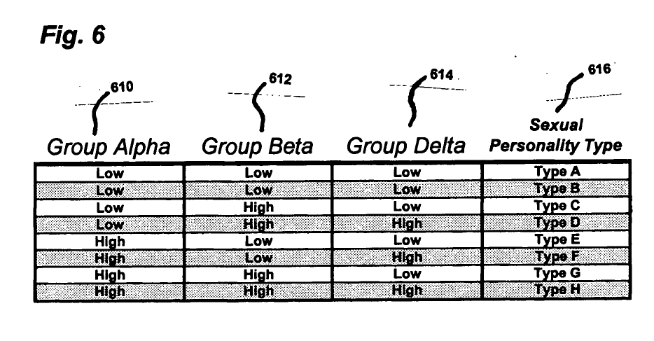

Referring back to FIG. 4, the final process of the present invention is the reporting process 414. The reporting process involves combining the results acquired during the qualifying process and testing process and reporting the information back to the user. The reporting process 414 requires that the information reported back to the user be in a format that is easily understood and easily read. FIG. 6 provides an example of how the characterizations of the user with respect to the different factors may be combined to report a particular sexual personality type to the user. Columns 610, 612, and 614 illustrate the possible combinations of Low/High determinations for three factors. Column 616 illustrates the associated Sexual Personality Type for each particular combination.

The information provided to the user in the reporting process may include, but is not limited to, a word identifying the particular sexual personality type, a list of compatible sexual personality types, a description of the various sexual personality types, a list of people with compatible sexual personality types within a particular geographic area, or any combination of the above information. Alternatively, the reporting process may be accomplished by providing the user with a list of other people who are compatible with the user's particular sexual personality type. In yet another embodiment, the reporting may consist of sending an email to the user with the results.

1. A method of evaluating a user's sexual compatibility for an online relationship and dating service comprising the steps of:
(a) qualifying the user with at least one qualifying question used to identify the user;
(b) testing the user with a plurality of adaptively selected testing questions used to evaluate the user's general preferences, individual preferences, and partner preferences.
(c) assigning the user to a sexual compatibility group based on the user's responses to the adaptively selected testing questions.

2. The method of claim 1, further comprising the step of:
(d) reporting to the user the assigned sexual compatibility group.

3. The method of claim 1, further comprising the step of:
(e) pairing the user to a second person within the same sexual compatibility group.

4. The method of claim 1, further comprising the step of:
(f) pairing the user to a second person within a complementary sexual compatibility group.

5. The method of claim 1, further comprising the step of:
(g) reporting to the user a list of people in the same sexual compatibility group.

6. The method of claim 1, further comprising the step of:
(h) reporting to the user a list of people in complementary sexual compatibility groups.
